(19) United States
(12) Patent Application Publication
(10) Pub. No.: US 2008/0057378 A1
(43) Pub. Date: Mar. 6, 2008

(54) Fuel Cells

(75) Inventors: Ku-Yen Kang, Hsinchu City (TW); Chun-Ho Tai, Hsinchu City (TW); Chiou-Chu Lai, Hsinchu (TW); Ying-Ying Hsu, Kaohsiung City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/551,568

(22) Filed: Oct. 20, 2006

(30) Foreign Application Priority Data
Sep. 5, 2006 (TW) TW95132721

(51) Int. Cl. H01M 4/86; H01M 8/10

(52) U.S. Cl. 429/40; 429/30

(57) ABSTRACT

A fuel cell. A membrane electrode assembly includes a proton exchange membrane, a cathode electrode, and an anode electrode. The proton exchange membrane is disposed between the cathode and anode electrodes. A cathode porous current collector is disposed on the cathode electrode. An anode porous current collector is disposed on the anode electrode and opposite the cathode porous current collector. A cathode water-absorptive layer is disposed on the cathode porous current collector, absorbing or guiding water at the cathode electrode.

### BACKGROUND OF THE INVENTION

1. Field of the Invention

The invention relates to fuel cells, and in particular to fuel cells effectively absorbing and/or removing excess water from cathode electrodes.

2. Description of the Related Art

Generally, in a fuel cell employing methanol (CH₃OH), a redox reaction at a cathode electrode and an anode electrode is as follows.

At the anode electrode: CH₃OH+H₂O→CO₂+6H⁺+6e⁻

At the cathode electrode: 3/2O₂+6H⁺+6e⁻→3H₂O

Accordingly, when the redox reaction occurs, one mole of water is consumed by the anode electrode and three moles of water are produced at the cathode electrode.

Referring to FIG. 1, a conventional monopolar fuel cell 1 comprises a proton exchange membrane 10, an anode catalyst layer 11, a cathode catalyst layer 21, an anode gas diffusion layer 12, a cathode gas diffusion layer 22, an anode current collector 13, and a cathode current collector 23. The proton exchange membrane 10 is disposed between the anode catalyst layer 11 and cathode catalyst layer 21. The anode gas diffusion layer 12 and cathode gas diffusion layer 22 are disposed on the anode catalyst layer 11 and cathode catalyst layer 21, respectively. The anode current collector 13 and cathode current collector 23 are disposed on the anode gas diffusion layer 12 and cathode gas diffusion layer 22, respectively. Moreover, the anode catalyst layer 11 and anode gas diffusion layer 12 can be regarded as an anode electrode, and the cathode catalyst layer 21 and cathode gas diffusion layer 22 regarded as a cathode electrode.

When a redox reaction occurs in the monopolar fuel cell 1, methanol (CH₃OH) reacts with one mole of water at the anode electrode to produce six moles of (hydrogen) proton (H⁺) and six moles of electron (e⁻). The six moles of (hydrogen) proton (H⁺) are conveyed to the cathode electrode through the proton exchange membrane 10 while the six moles of electron (e⁻) are conveyed to the cathode electrode via an external loop. At the cathode electrode, external oxygen (O₂) is transmitted to the cathode catalyst layer 21 through the cathode current collector 23 and cathode gas diffusion layer 22 and reacts with six moles of (hydrogen) proton (H⁺) and electron (e⁻) to produce three moles of water. Accordingly, a large amount of water is often accumulated over the surface of the cathode electrode. Water films or droplets are thus formed on the cathode current collector 23 or cathode gas diffusion layer 22 by excess water, preventing the external oxygen (O₂) from being transmitted to the cathode catalyst layer 21, and further adversely affecting performance of the monopolar fuel cell 1.

Consequently, absorption or removal of excess water at a cathode electrode of a fuel cell is critical.

U.S. Patent Publication No. 2002/0076599 discloses a fuel cell with a hydrophilic thread composed of polyester fiber material and disposed under or above a gas diffusion layer (between a current collector and the gas diffusion layer). Conduction of electrons in a membrane electrode assembly (MEA) is adversely affected by the hydrophilic thread. Thus, the fiber thickness and amount of the hydrophilic thread are restricted.

Japan Patent Publication No. 2004-165002A discloses a fuel cell with a water-absorptive material disposed on the top portion and side of a gas diffusion layer. A current collector of the fuel cell cannot completely contact the gas diffusion layer, thus increasing the total resistance in the fuel cell. Moreover, to conform to the profile of the water-absorptive material, the current collector must be non-planar, increasing difficulty of manufacture thereof. Additionally, as extra area of the gas diffusion layer causes a decrease in the proportion of the whole effective reactive area, the density of power generation of the fuel cell decreases. Furthermore, as the water-absorptive material, is disposed on the edge of a membrane electrode assembly (MEA), a long route for absorbing water in the center of the membrane electrode assembly (MEA) exists, thus causing poor capability of drainage.

U.S. Patent Publication No. 2005/0026026 discloses a fuel cell with a porous reticular conductor tightly attached to a gas diffusion layer. The fuel cell, however, does not disclose any mechanism capable of effectively absorbing excess water.

Hence, there is a need for a fuel cell with a cathode water-absorptive layer disposed on a cathode porous current collector. The cathode water-absorptive layer effectively removes excess water from a cathode electrode, preventing additional electronic impedance.

### BRIEF SUMMARY OF THE INVENTION

A detailed description is given in the following embodiments with reference to the accompanying drawings.

An exemplary embodiment of the invention provides a fuel cell comprising a membrane electrode assembly, a cathode porous current collector, an anode porous current collector, and a cathode water-absorptive layer. The membrane electrode assembly comprises a proton exchange membrane, a cathode electrode, and an anode electrode. The proton exchange membrane is disposed between the cathode and anode electrodes. The cathode porous current collector is disposed on the cathode electrode. The anode porous current collector is disposed on the anode electrode and opposite the cathode porous current collector. The cathode water-absorptive layer is disposed on the cathode porous current collector, absorbing or guiding water at the cathode electrode.

The cathode water-absorptive layer comprises porous hydrophilic material. The porous hydrophilic material comprises a hydrophilic thread, a lampwick, woven fabrics, non-woven fabrics, paper, foam sponge, or foaming PU.

The cathode water-absorptive layer is coated or printed on the cathode porous current collector.

The fuel cell further comprises a press board disposed on the cathode porous current collector, fixing the cathode porous current collector. The cathode water-absorptive layer is disposed on the press board. The press board comprises porous hydrophilic material.

The fuel cell further comprises a water storage connected to the cathode water-absorptive layer. Water at the cathode electrode is guided to the water storage from the cathode water-absorptive layer.

The cathode water-absorptive layer comprises a plurality of through holes. Air is transmitted to the cathode electrode via the through holes and cathode porous current collector. The size of the through holes of the cathode water-absorptive layer must be carefully designed, preventing overflow at the cathode electrode. A through hole cannot be blocked by a water droplet on the surface thereof. The radius of the through holes must exceed the thickness of the cathode water-absorptive layer.

The cathode water-absorptive layer reduces contact resistance between the cathode porous current collector and the cathode gas diffusion layer and enhances permeability of air transmitted to the cathode electrode. The hydrophilic or water-absorptive thread in Japan Patent Publication No. 2004-165002A and U.S. Patent Publication No. 2002/0076599 is disposed in the gas diffusion layer or on a partial surface thereof. Liquid water is not deposited in the gas diffusion layer, such that gas diffusion is not adversely affected. However, in a monopolar fuel cell, the cathode porous current collector, disposed in the exterior of the gas diffusion layer is more hydrophilic than the gas diffusion layer. According to temperature distribution of the fuel cell, the surface temperature of the cathode porous current collector is lower, such that vapor easily condenses, thereby causing widespread overflow. The aforementioned widespread overflow is worse than overflow in the interior of the gas diffusion layer or on the partial surface thereof. Although the gas diffusion layer comprises the hydrophilic material, the water is removed from the carbonaceous material to the hydrophilic material. If the water is not removed, the gas diffusion rate cannot be promoted.

The cathode water-absorptive layer of the invention is disposed on the surface of the cathode porous current collector. As the cathode water-absorptive layer comprises porous material, the physical surface area of the cathode water-absorptive layer is greater than the geometric surface area thereof, accelerating vaporization of water. Alternatively, the water can be removed by, alternatively, avoiding formation of the liquid water at the cathode water-absorptive layer. Moreover, the cathode water-absorptive layer can be coated or printed on the surface of the cathode porous current collector or on the sides of the through holes thereof. The liquid water accumulated between the cathode porous current collector and the cathode gas diffusion layer is transported to the top of the cathode porous current collector by capillarity. Gas diffusion between the cathode porous current collector and the cathode gas diffusion layer and uniformity of gas supply are thus enhanced.

### BRIEF DESCRIPTION OF THE DRAWINGS

The invention can be more fully understood by reading the subsequent detailed description and examples with references made to the accompanying drawings, wherein:

FIG. 1 is a schematic cross section of a conventional monopolar fuel cell;

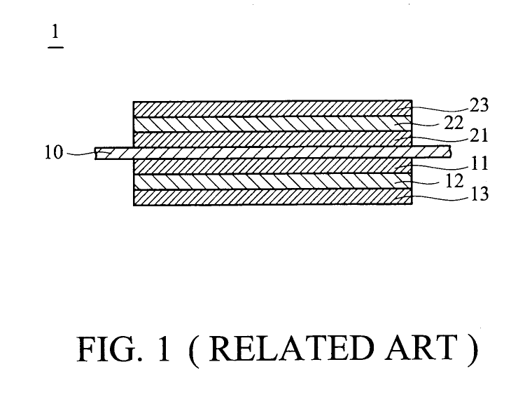

FIG. 2 is a schematic cross section of a fuel cell of a first embodiment of the invention;

FIG. 3 is a schematic cross section of a fuel cell of a second embodiment of the invention; and

FIG. 4 is a schematic partial cross section of a fuel cell of a third embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

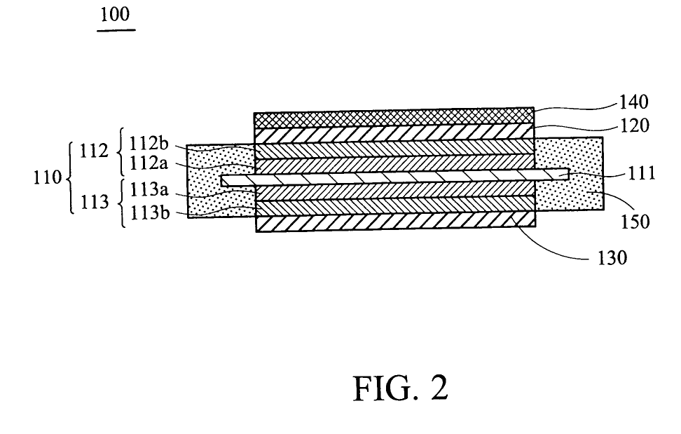

Referring to FIG. 2, a fuel cell 100 comprises a membrane electrode assembly 110, a cathode porous current collector 120, an anode porous current collector 130, a cathode water-absorptive layer 140, and a frame 150. The frame 150 fixes the membrane electrode assembly 110.

The membrane electrode assembly 110 comprises a proton exchange membrane 111, a cathode electrode 112, and an anode electrode 113. The proton exchange membrane 111 is disposed between the cathode electrode 112 and the anode electrode 113. Specifically, the cathode electrode 112 comprises a cathode catalyst layer 112a and a cathode gas diffusion layer 112b, and the anode electrode 113 comprises an anode catalyst layer 113a and an anode gas diffusion layer 113b. The proton exchange membrane 111 is disposed between the cathode catalyst layer 112a and the anode catalyst layer 113a. The cathode gas diffusion layer 112b is disposed on the cathode catalyst layer 112a. The anode gas diffusion layer 113b is disposed on the anode catalyst layer 113a.

The cathode porous current collector 120 is disposed on the cathode electrode 112. Specifically, the cathode porous current collector 120 is disposed on the cathode gas diffusion layer 112b of the cathode electrode 112.

The anode porous current collector 130 is disposed on the anode electrode 113. Specifically, the anode porous current collector 130 is disposed on the anode gas diffusion layer 113b of the anode electrode 113 and opposite the cathode porous current collector 120.

The cathode water-absorptive layer 140 is disposed on the cathode porous current collector 120. Compared to the cathode porous current collector 120, the cathode water-absorptive layer 140 is hydrophilic and can rapidly absorb water or guide water to other areas, preventing the water from being accumulated at the cathode porous current collector 120 or cathode electrode 112. The cathode water-absorptive layer 140 may comprise porous hydrophilic material, such as a hydrophilic thread, a lampwick, woven fabrics, non-woven fabrics, paper, foam sponge, or foaming PU. The porous hydrophilic material, such as foaming PU, may be directly attached to the cathode porous current collector 120 by coating. Specifically, disposed in the exterior of the cathode porous current collector 120, the cathode water-absorptive layer 140 does not adversely affect electrical contact between the cathode porous current collector 120 and the cathode gas diffusion layer 112b. Thus, the total resistance in the fuel cell 100 is not increased. Moreover, the cathode water-absorptive layer 140 is provided with sufficient capillary surface area. Small size and a large amount of capillary surface are preferred. To effectively promote permeability of air, the size of the capillary surface or through holes is determined by surface energy provided by the cathode water-absorptive layer 140 without formation of any water film, such that oxygen can easily enter the cathode electrode 112. Specifically, the radius of the capillary surface or through holes must exceed the thickness of the cathode water-absorptive layer 140, such that water droplets on the edges thereof do not connect to each other and form water films to clog up the capillary surface or through holes.

### Second Embodiment

Elements corresponding to those in the first embodiment share the same reference numerals.

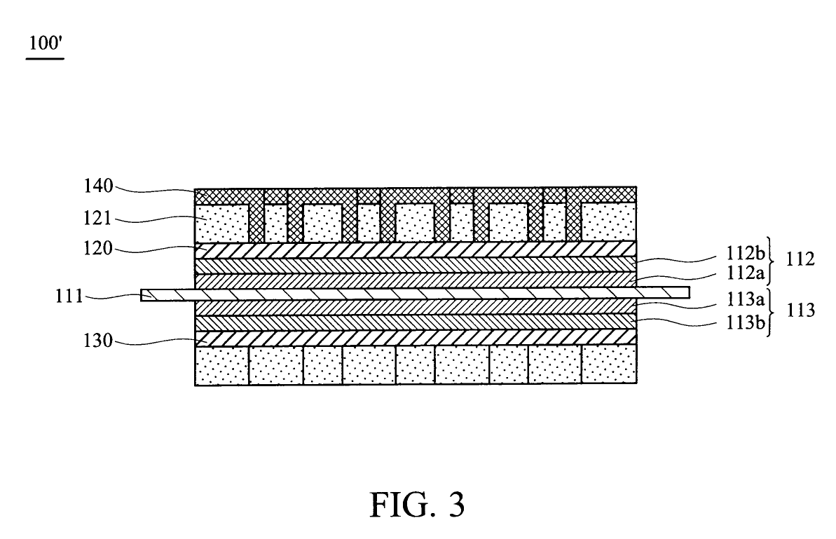

Referring to FIG. 3, in this embodiment, the cathode porous current collector 120 of the fuel cell 100′ is pressed and fixed by a press board 121 with high rigidity, such that contact resistance between the cathode porous current collector 120 and the cathode gas diffusion layer 112b is reduced. The cathode water-absorptive layer 140 is disposed on the press board 121, enhancing contact of the cathode water-absorptive layer 140 and the water at the cathode electrode 112. Moreover, the press board 121 may comprise porous hydrophilic material, absorbing or removing the excess water from the cathode electrode 112.

Structure, disposition, and function of other elements in the fuel cell 100′ are the same as those in the fuel cell 100, and explanation thereof is omitted for simplicity.

### Third Embodiment

Elements corresponding to those in the first embodiment share the same reference numerals.

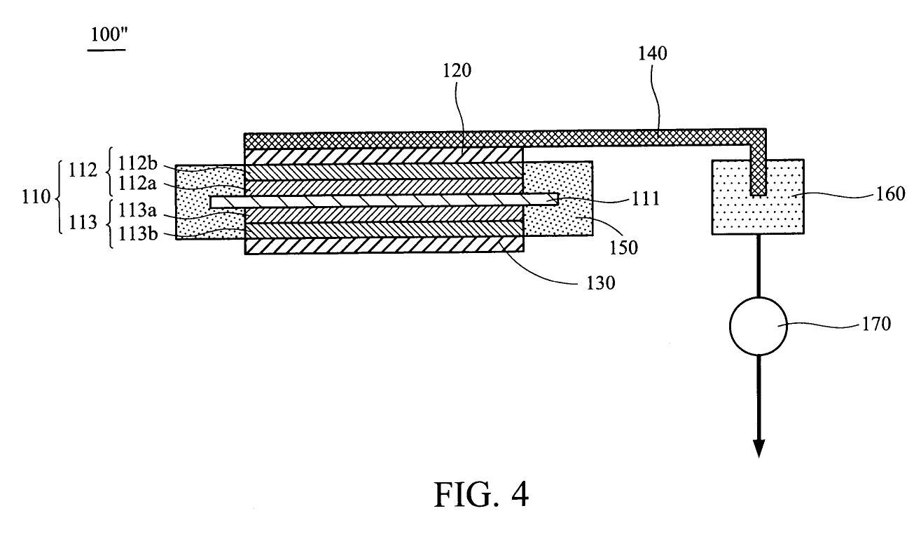

Referring to FIG. 4, in this embodiment, the cathode water-absorptive layer 140 of the fuel cell 100″ guides the water produced at the cathode electrode 112 to a water storage 160 by capillarity or gravity. The water storage 160 may comprise water-absorptive material (such as foam sponge) or be a tank, storing the water from the cathode electrode 112. Additionally, a fluid transportation device 170, such as a pump or a compressor, is connected to the water storage 160. The fluid transportation device 170 transports the water stored in the water storage 160 to the anode electrode 113 or a recycling area (not shown) within a proper or predetermined time period, mixing with methanol. For example, when the water storage 160 is higher than the anode electrode 113, the fluid transportation device 170 may be an electromagnetic valve, a one-way valve, or a guide pipe. The water in the water storage 160 flows to the anode electrode 113 by gravity and is applied thereby.

Structure, disposition, and function of other elements in the fuel cell 100″ are the same as those in the fuel cell 100, and explanation thereof is omitted for simplicity.

Accordingly, in the fuel cell 100″, the excess water at the cathode electrode 112 and adversely affecting the redox reaction is effectively recycled or transported to the anode electrode 113 for reaction. Thus, the fuel cell 100″ can provide long-term operation.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell, comprising:
a membrane electrode assembly comprising a proton exchange membrane, a cathode electrode, and an anode electrode, wherein the proton exchange membrane is disposed between the cathode and anode electrodes;
a cathode porous current collector disposed on the cathode electrode;
an anode porous current collector disposed on the anode electrode and opposite the cathode porous current collector; and
a cathode water-absorptive layer disposed on the cathode porous current collector, absorbing or guiding water at the cathode electrode.

2. The fuel cell as claimed in claim 1, wherein the cathode water-absorptive layer comprises porous hydrophilic material.

3. The fuel cell as claimed in claim 2, wherein the porous hydrophilic material comprises a hydrophilic thread, a lampwick, woven fabrics, non-woven fabrics, paper, foam sponge, or foaming PU.

4. The fuel cell as claimed in claim 1, wherein the cathode water-absorptive layer is coated or printed on the cathode porous current collector.

5. The fuel cell as claimed in claim 1, further comprising a press board disposed on the cathode porous current collector, fixing the cathode porous current collector.

6. The fuel cell as claimed in claim 5, wherein the cathode water-absorptive layer is disposed on the press board.

7. The fuel cell as claimed in claim 5, wherein the press board comprises porous hydrophilic material.

8. The fuel cell as claimed in claim 1, further comprising a water storage connected to the cathode water-absorptive layer, wherein water at the cathode electrode is guided to the water storage from the cathode water-absorptive layer.
